(19) United States
(12) Patent Application Publication
(10) Pub. No.: US 2024/0425149 A1
(43) Pub. Date: Dec. 26, 2024

(54) Floatable Offshore Structure

(71) Applicants: Jörn Runge, Essen (DE); Aron von Schéele, Essen (DE); Pascal Deus, Essen (DE)

(72) Inventors: Jörn Runge, Essen (DE); Aron von Schéele, Essen (DE); Pascal Deus, Essen (DE)

(73) Assignee: RWE Offshore Wind GmbH, Essen (DE)

(21) Appl. No.: 18/830,747

(22) Filed: Sep. 11, 2024

Related U.S. Application Data
(63) Continuation of application No. PCT/EP2023/057909, filed on Mar. 28, 2023.

(30) Foreign Application Priority Data
Apr. 21, 2022 (DE) 10 2022 109 688.2

(51) Int. Cl. B63B 21/50; B63B 21/00; B63B 35/44; H02G 9/02; H02G 9/12; H02H 5/10

(52) U.S. Cl. CPC B63B 21/50; B63B 35/44; H02G 9/02; H02G 9/12; H02H 5/10; B63B 2021/003; B63B 2035/444; B63B 2035/4453; B63B 2035/446

(57) ABSTRACT

A floatable offshore structure includes at least one submarine power cable connector configured to connect a submarine power cable. At least one anchor connector is configured to connect at least one anchor connection for anchoring the floatable offshore structure to an underwater bottom, at least one detection arrangement configured to detect an anchor connection breakage indication, and at least one switching equipment configured to at least electrically disconnect the electrical connection to the submarine power cable connected to the submarine power cable connector upon or after the detection of an anchor connection breakage indication.

### CROSS-REFERENCE TO RELATED PATENT APPLICATIONS

This patent application is a continuation of International Application No. PCT/EP2023/057909, filed on Mar. 28, 2023, which claims the benefit of priority to German Patent Application No. 10 2022 109 688.2, filed Apr. 21, 2022, the entire teachings and disclosures of both applications are incorporated herein by reference thereto.

### FIELD OF THE INVENTION

The application relates to a floatable offshore structure comprising at least one submarine power cable connector configured to connect a submarine power cable and at least one anchor connector configured to connect at least one anchor connection for anchoring the floatable offshore structure to an underwater bottom. Furthermore, the application relates to a (floatable) power generation system, a method and a use.

### BACKGROUND OF THE INVENTION

In modern times, power generation systems are increasingly used for the provision of electrical energy, wherein in power generation systems the generation of electrical energy is based on so-called renewable energy sources. Electric power generation systems comprise at least one power generation device, preferably a plurality of power generation devices.

For example, wind energy systems and wind farms, respectively, having at least one wind turbine as the energy generation device are used as electrical energy generation systems. A wind turbine is configured in particular to convert the kinetic wind energy into electrical energy. In addition to wind energy systems and wind farms, respectively, photovoltaic systems and photovoltaic farms, respectively, are also increasingly being configured as electrical energy generation systems, in which a plurality of photovoltaic modules are generally provided for electrical energy generation.

Such power generation systems are not only found at onshore sites, but increasingly also at offshore sites. There are many reasons for choosing an offshore site: For example, the available space on land may be limited. In addition, it has been shown that the energy yield can be increased in wind farms, for example. Offshore locations are usually characterized by relatively continuous wind conditions and high average wind speeds so that so-called offshore wind energy systems and offshore wind farms, respectively, are increasingly being built, for example. Offshore photovoltaic parks, for example, may be installed due to space constraints.

Typically, an offshore power generation system has a plurality of offshore structures, such as a plurality of offshore wind turbines and at least one offshore substation by which an offshore wind farm is electrically connected, for example, to an onshore substation or a further offshore substation and offshore converter station, respectively.

An onshore substation, in turn, may be connected to a public power grid. In order to transmit electrical energy between two offshore structures or an offshore structure and an onshore structure, power cables in the form of submarine power cables are laid between the aforementioned structures.

While it has been common practice up to now for offshore wind turbines and offshore substations, but also for other offshore structures such as photovoltaic platforms, platforms for gas or oil exploration etc., to anchor these structures by means of a foundation structure (e.g. monopile, tripod, tripile or jacket foundations) on respectively in the underwater bottom, in particular a seabed, there are increasing considerations to install floating respectively floatable offshore structures, for example floatable power generation devices, such as floatable offshore wind turbines or floatable photovoltaic platforms.

One reason for using floatable offshore structures is the possibility of installing such offshore structures in areas with a large water depth, for example, of more than 150 meters.

A floatable and floating, respectively, offshore structure may comprise at least one floatable foundation having at least one floating body. A device having at least one submarine power cable connector may be arranged on the floatable foundation. In variants, the submarine power cable connector may also be arranged at the foundation. A submarine power cable connector is configured to connect a submarine power cable.

For example, the device installed on the foundation may be a transformer device with at least one transformer, a wind power device, a photovoltaic device, a hydrogen production device, etc.

For a (permanent) stationary operation of the offshore structure at a specific installation site, the offshore structure is attached to the underground bottom (typically a seabed) by at least one anchoring arrangement. The at least one anchoring arrangement is configured to fix the offshore structure to an underwater bottom in an anchoring state of the offshore structure.

To this end, the anchoring arrangement may comprise at least one anchor connection extending between an anchor that is at least partially buried in the underwater bottom and the floatable offshore structure. Thus, the offshore structure comprises at least one anchor connection. The anchor connector is configured to connect at least one anchor connection for anchoring the floatable offshore structure to the underwater bottom. In variants, two or more anchor connections may also be connected and attached, respectively, to one anchor connector.

A problem with the described floatable offshore structures is that an anchor connection can break respectively be severed during the operation of an offshore structure. An anchor connection can break, for example, due to the high mechanical loads acting on an anchor connection during operation, an accident with a watercraft or the like.

As a result of a broken anchor connection, the electrically live connected submarine power cable may break. A breaking of a live connected submarine power cable leads to a short circuit and thus entails a high safety risk since high currents regularly flow through submarine power cables and/or high voltages are applied to such a cable.

### SUMMARY OF THE INVENTION

Therefore, the object of the application is to provide a floatable offshore structure with a submarine power cable connector for connecting a submarine power cable, wherein the safety is increased during operation of the floatable offshore structure.

According to a first aspect of the application, the object is solved by a floatable offshore structure according to claim 1. The floatable offshore structure comprises at least one submarine power cable connector. The at least one submarine power cable connector is configured to connect a submarine power cable. The floatable offshore structure comprises at least one anchor connector. The at least one anchor connector is configured to connect at least one anchor connection for anchoring the floatable offshore structure to an underwater bottom. The floatable offshore structure comprises at least one detection arrangement. The at least one detection arrangement is configured to detect an anchor connection breakage indication (e.g., a broken anchor connection of the floatable offshore structure or an anchor connection condition of an anchor connection of the floatable offshore structure wherein the anchor connection is at risk of breaking due to high loading). The floatable offshore structure comprises at least one switching equipment. The at least one switching equipment is configured to at least electrically disconnect (respectively switch off respectively disconnect) the electrical connection to the submarine power cable connected to the submarine power cable connector upon or after a detection of an anchor connection breakage indication.

By providing, in contrast to the prior art, a floatable offshore structure comprising a detection arrangement for detecting an anchor connection breakage indication, in particular a breakage of an anchor connection respectively a disconnected anchor connection, and a switching equipment which interrupts the current flow and the power transmission, respectively, through a connected submarine power cable upon such a detection, the safety during operation of the floatable offshore structure is increased. A breakage of a live submarine power cable is (securely) prevented. An unintentional short circuit is avoided.

The offshore structure according to the application is a floatable offshore structure respectively an offshore structure that floats during operation. The floatable offshore structure and floating offshore structure, respectively, comprises at least one submarine power cable connector. For example, two submarine power cable connectors may be provided. A submarine power cable connector is provided for connecting a submarine power cable during operation of the offshore structure. For example, two submarine power cables may be connected to an offshore structure.

In particular, a submarine power cable is configured to transmit electrical energy. The submarine power cable is preferably a medium-voltage submarine cable (in particular between 3 kV to 30 kV) or a high-voltage submarine cable (60 kV to 110 kV). The power capacity of a submarine power cable according to the application is preferably between 3 MW and 2.5 GW. In addition, a submarine power cable can also be configured for data transmission.

In particular, a submarine power cable according to the application may run from the submarine power cable connector to the underwater bottom and then in the underwater bottom in a specific depth range. If the further connected structure is also an offshore structure, the submarine power cable may then run from the underwater bottom to a further submarine power cable connector of the further (floatable) offshore structure. If the further connected structure is an onshore structure, the submarine power cable may run substantially in the bottom to the further submarine power cable connector of the onshore structure.

According to a preferred embodiment of the offshore structure according to the application, the floatable offshore structure may comprise a foundation having at least one floating body. The floatable offshore structure may comprise at least one device arranged on the foundation. This device may comprise the at least one submarine power cable connector. Preferably, the device may be an electrical power generation device. Exemplary and non-exhaustive devices comprising a submarine power cable connector comprise transformer devices comprising at least one electrical transformer, wind power devices (e.g., comprising a tower, nacelle, rotor, generator, etc.), photovoltaic devices (preferably comprising a plurality of photovoltaic modules), and hydrogen production devices, in particular a water electrolysis device.

As has already been described, the at least one floatable foundation may comprise at least one floating body. A floating body and buoyant body, respectively, is independently buoyant in particular due to its buoyancy by displacement according to the Archimedes' principle. Floating bodies may, for example, be hollow and filled with air or with a light solid material. In particular, the floatable foundation may substantially form the floating body.

The floatable foundation may preferably be a so-called barge foundation, semi-submersible foundation, spar foundation and/or tension leg platform (TLP) foundation. It shall be understood that other types of floatable foundations may be provided in other variants of the application.

According to the application, the offshore structure comprises at least one anchor connector. In particular, the foundation may comprise at least one anchor connection. An anchor connection is configured to (mechanically) connect at least one anchor connection. In operation, the offshore structure is attached and anchored, respectively, to the underwater bottom by means of the at least one anchor connection.

An anchor connection according to the application is preferably an anchor rope and/or an anchor chain. An anchor rope may be formed of metal, in particular steel, and/or plastic, in particular at least one fiber composite material. Preferably, two or more anchor ropes may be twisted together to form an anchor connection. A sheathing may be provided to protect the at least one anchor rope.

One end of the anchor connection is connected (in the installation state of the floatable offshore structure) to the anchor connector and the other end of the anchor connection is connected to an anchor (e.g., weight anchor, torpedo anchor, etc.). The anchor may be at least partially buried in the underwater bottom. In particular, the anchor and anchor connection form an anchoring arrangement. Preferably, a floatable offshore structure may have three anchor connections, which may be attached, for example, to a corresponding number of anchor connectors of the offshore structure.

According to the application, it has been recognized that the operational safety of a floatable offshore structure to which at least one submarine power cable is connected is improved by implementing a detection arrangement for detecting an anchor connection breakage indication, in particular an (actually) broken anchor connection, and a switching equipment connected to the detection arrangement.

The detection arrangement is used for direct and/or indirect monitoring of the at least one anchor connection of the floatable offshore structure, in particular of all anchor connections of the floatable offshore structure. In particular, the detection arrangement is provided for detecting a broken anchor connection and a severed anchor connection, respectively. A broken anchor connection is at least present if the mechanical respectively structural connection to the anchor of the anchoring arrangement is disconnected.

By a detection of an anchor connection breakage indication is meant the detection of a specific event respectively a specific parameter that indicates an (actually or potentially) broken anchor connection or an anchor connection with a high probability (e.g., >95%) to break (for example due to a current load on the anchor connection exceeding a predetermined maximum permissible load). In particular, a potentially broken anchor connection is present if the detection arrangement detects a parameter and event, respectively, that indicates a broken anchor connection, but may also have other causes, such as a defect in the detection arrangement (e.g., a measurement error or the like).

Upon or after the detection of at least one anchor connection breakage indication, in particular a broken anchor connection, at least one electrical disconnecting of the connection to the submarine power cable connected to the floatable offshore structure respectively the electrical system of the floatable offshore structure is performed by the switching equipment. In particular, an interrupting of the flow of current respectively an interrupting of the flow of energy through the at least one submarine power cable connected to the floatable offshore structure is performed. In other words, the at least one submarine power cable is de-energized by the switching equipment. In particular, the switching equipment may disconnect and interrupt, respectively, the flow of current respectively flow of energy to all of the submarine power cables connected to the floatable offshore structure. For example, the switching equipment may comprise at least one switching module for each connected submarine power cable. The electrical disconnecting here comprises, in particular, (proper) grounding. This eliminates the risk of a short circuit.

In particular, the switching equipment is formed in the form of a protective circuit and breakaway circuit, respectively. According to the application, upon or after a detection means in particular that the described disconnecting is performed at least within a specific period of time after the detection of the anchor connection breakage indication. The specific period of time may be at least less than 10 seconds, in particular less than 5 seconds, particularly preferably less than 1 second. In other words, the switching equipment may preferably be configured to electrically disconnect immediately (i.e., in particular within a period of less than 1 second) upon or after the detection of the anchor connection breakage indication, in particular a broken anchor connection. This means in particular that the switching equipment is triggered immediately upon or after the detection of the anchor connection breakage indication, in particular of the at least one broken anchor connection, in such a way that the at least one submarine power cable is immediately de-energized.

According to a preferred embodiment of the floatable offshore structure according to the application, the detection arrangement may comprise at least one position sensor. The at least one position sensor may be configured to detect the (instantaneous) position of the floatable offshore structure.

The detection arrangement may comprise at least one position evaluation module. The position evaluation module may be configured to detect the anchor connection breakage indication based on the detected position and a predetermined permissible position range.

The at least one position sensor may in particular be a satellite-based position sensor. For example, a GPS sensor, Galileo sensor, etc. may be provided as a position sensor.

In particular, the at least one position sensor is configured for substantially continuous detection of the instantaneous geographic position of the floatable offshore structure. In other words, a localization of the floatable offshore structure can in particular be performed continuously.

The detected position and the detected position data, respectively, in particular in the form of geographical coordinates (e.g., GPS data), can be provided (continuously) to the position evaluation module. In particular, the position evaluation module is configured to evaluate the detected position respectively the detected position data for detecting an anchor connection breakage indication, in particular a broken anchor connection. In particular, it has been recognized according to the application that based on the instantaneous position of the offshore structure, the condition (e.g., broken or intact) of the at least one anchor connection can be (indirectly) concluded.

Preferably, a permissible (geographic) position range of the floatable offshore structure is predetermined. In particular, the permissible position range can be determined before and/or during commissioning of the floatable offshore structure. In particular, the permissible position range specifies the maximum possible range of movement of a floatable offshore structure anchored to the underwater bottom by at least one anchor connection and may depend, for example, on parameters such as the length (e.g., over 1000 m) of the at least one anchor connection, the number of connected anchor connections, and/or a length buffer provided for the at least one submarine power cable.

For example, the longer the at least one anchor connection is or the greater the water depth is at the installation site of the floatable offshore structure, the greater the radius of motion of the offshore structure in operation. The submarine power cable may have a length buffer and length margin, respectively, that takes into account the maximum possible radius of movement. The length buffer may be achieved, for example, by an S-shaped cable curve of the submarine power cable from the offshore structure to the underwater bottom, which curve may be provided by means of at least one floating body arranged at the submarine power cable. In particular, the length buffer is selected such that it is ensured that the submarine power cable is not damaged when the offshore structure is moving within the maximum radius of movement.

The permissible position range can be the same as the maximum radius of movement or preferably (slightly (e.g., 5%)) larger, with the maximum radius of movement fully enclosed. The permissible position range ensures in particular that small position deviations due to measurement inaccuracy, but also caused by the weather conditions at the installation site, do not lead to a triggering of the switching equipment. Only larger deviations, which could endanger the submarine power cable, lead to the triggering of the switching equipment. The permissible position range can be defined in particular by limit position data (e.g., geographical coordinates, such as GPS coordinates). As long as the detected position data of the floatable offshore structure is within the permissible position range, it can be assumed that the at least one anchor connection is intact and not broken, respectively. A disconnecting of the current flow is omitted in this case.

If, on the other hand, the detected position data of the floatable offshore structure is outside the permissible position range, an event and parameter, respectively, may be detected that indicates that the at least one anchor connection is (potentially or actually) broken respectively disconnected (or imminently likely (>95%) to break).

The position evaluation module can in particular be configured to (continuously) compare the detected position respectively the detected position data with the permissible position range. If it is determined that the detected position respectively the detected position data of the offshore structure is/are outside the permissible position range, the switching equipment can be triggered (immediately) in the described manner. In a secure manner, a broken anchor connection can in particular be detected without the need for additional sensors to monitor an anchor connection.

In variants of the application, it can be provided that the switching equipment is only triggered in the described manner when the detected position respectively the detected position data of the offshore structure is/are outside the permissible position range for a specific (predefined) period of time (e.g., between 0.5 s and 10 s). In the event that the detected position of the offshore structure is again within the permissible range before the aforementioned period of time has elapsed, the switching equipment may not be triggered.

According to a further embodiment of the floatable offshore structure according to the application, the detection arrangement may comprise (alternatively or in addition to the position sensor) at least one anchor connection structure sensor. The anchor connection structure sensor may be configured to (substantially continuously) detect at least one anchor connection structure parameter of the anchor connection of the floatable offshore structure. In particular, this means that by the anchor connection structure sensor the structural integrity of the anchor connection of the floatable offshore structure can be monitored.

The detection arrangement may comprise (alternatively or in addition to the position evaluation module) at least one anchor connection structure evaluation module. The anchor connection structure evaluation module may be configured to detect the anchor connection breakage indication based on the at least one detected anchor connection structure parameter and in particular at least one predetermined permissible anchor connection structure parameter range. In particular, the anchor connection structure evaluation module may evaluate the detected anchor connection structure parameter values substantially continuously.

In particular, the permissible anchor connection structure parameter range defines a parameter range at which the at least one anchor connection of the floatable offshore structure is intact and is not broken, respectively, (and, in particular, is not yet in imminent danger of breaking). In particular, at least one limit connection structure parameter value may be specified.

As long as the detected anchor connection structure parameter values of the at least one anchor connection are within the permissible anchor connection structure parameter range, it can be assumed that the at least one anchor connection is intact and has not broken, respectively. In this case, in particular, electrical disconnection of the current flow can be omitted. If, on the other hand, the detected anchor connection structure parameter values are outside the permissible anchor connection structure parameter range, an event and parameter, respectively, can be detected that indicates that the at least one anchor connection is (potentially or actually) broken respectively disconnected (or is immediately threatening to break with a high probability (>95%)).

The anchor connection structure evaluation module can in particular be configured to (continuously) compare the detected anchor connection structure parameter values with the permissible anchor connection structure parameter range. If it is determined that the detected anchor connection structure parameter values are outside the permissible anchor connection structure parameter range, the switching equipment can be triggered (immediately) in the described manner.

According to a particularly preferred embodiment of the floatable offshore structure according to the application, the detection arrangement may comprise, in particular as an anchor connection structure sensor, at least one electrical sensor equipment. The electrical sensor equipment may be configured to (substantially continuously) detect at least one electrical parameter of an electrical conductor guided at least partially along the anchor connection. The detection arrangement may comprise, in particular as an anchor connection structure evaluation module, at least one electrical evaluation module. The electrical evaluation module may be configured to detect an anchor connection break indication based on the at least one detected electrical parameter and in particular at least one predetermined permissible electrical parameter range.

The electrical sensor equipment may be part of an electrical sensor arrangement. The sensor arrangement may further comprise an electrical (measurement) conductor having, for example, a forward line and a return line. In one embodiment, the floatable offshore structure may comprise the at least one electrical sensor arrangement (and in particular the one anchor connection monitored thereby).

A forward line of an electrical conductor may preferably extend from the end of the anchor connection connected to the anchor connector to the other end of the anchor connection attached to the anchor. The return line of the electrical conductor may immediately follow the forward line and extend from the other end of the anchor connection to the end of the anchor connection connected to the anchor connector. The electrical sensor equipment may be connected to the forward line and the return line.

The electrical conductor can be arranged at the anchor connection in such a way that if the anchor connection breaks, the electrical conductor also breaks (at least almost simultaneously). In the case of an anchor rope, for example, the electrical conductor can be integrated in the anchor rope. In an anchor chain, the conductor may be guided, for example, through eyelets attached to the chain links. The conductor may comprise at least one phase conductor surrounded by an insulation layer.

The electrical sensor equipment may in particular comprise a generator configured to apply a specific voltage and/or a specific current to the electrical conductor (in particular the forward and return lines). Furthermore, the electrical sensor equipment can comprise at least one measuring module for detecting, in particular measuring, at least one electrical parameter (e.g., voltage, current, magnetic field, electric field, etc.) resulting from the electrical parameter applied by the generator and the state (e.g., broken or not broken) of the electrical conductor.

As has been described, the electrical conductor is attached to the anchor connection in such a way that if the anchor connection breaks, the electrical conductor also breaks (simultaneously). A breaking respectively severing of the electrical conductor causes a detectable change in the at least one detected electrical parameter. In particular, a breaking of the electrical conductor causes a change in the detected electrical parameter in such a way that the detected electrical parameter (value) is no longer within the predetermined permissible electrical parameter range.

The permissible electrical parameter range defines in particular a parameter range of a measured electrical parameter (e.g., voltage, current, magnetic field, electric field, etc.) at which the electrical conductor and thus also the at least one anchor connection is intact and has not broken, respectively. In particular, at least one electrical limit parameter value may be predetermined.

As long as the detected electrical parameter values of the at least one detected electrical parameter are within the permissible parameter range, it can be assumed that the at least one anchor connection is intact and has not broken, respectively. An electrical disconnecting of the current flow is omitted. If, on the other hand, the at least one detected electrical parameter value is outside the permissible parameter range, an event respectively parameter can be detected that indicates that the at least one anchor connection is (potentially or actually) broken respectively disconnected (or immediately threatened to break with a high probability (>95%)).

The electrical evaluation module can be configured in particular to (continuously) compare the detected electrical parameter values with the permissible parameter range. If it is determined that the detected parameter values are outside the permissible position range, the switching equipment can be triggered (immediately) in the described manner. A reliable detection in particular of an actually broken anchor connection can be provided.

Alternatively or additionally, in one embodiment of the floatable offshore structure according to the application, the detection arrangement may comprise at least one optical sensor equipment. The optical sensor equipment may be configured to detect at least one optical parameter of an optical conductor guided at least partially along the anchor connection. The detection arrangement may comprise at least one optical evaluation module. The optical evaluation module may be configured to detect the anchor connection breakage indication based on the at least one detected optical parameter and in particular at least one predetermined permissible optical parameter range.

Preferably, an optical sensor arrangement may comprise the optical sensor equipment and additionally the at least one optical conductor. The floatable offshore structure may comprise the optical sensor arrangement (and in particular the one anchor connection monitored thereby).

The optical conductor is in particular an optical waveguide, which can preferably be formed as a linear state sensor. The optical conductor can have at least one optical fiber, which can be surrounded by a protective layer. In particular, the optical conductor is configured to enable a detecting of at least one optical parameter that is at least indicative of the mechanical respectively structural condition of the anchor connection.

For example, vibrations (or acoustic emissions) of the anchor connection can be detected. These can then be evaluated to draw conclusions about the mechanical respectively structural condition of the anchor connection of the floatable offshore structure. In particular, the optical conductor connected to the optical sensor equipment can be used to detect a (potential or actual) breaking of the anchor connection or at least a mechanical load with a high probability (>95%) of breakage.

In particular, the optical conductor is integrated in the anchor connection, for example at least surrounded respectively enclosed by the (outer) sheathing of an anchor rope (in the radial direction). Alternatively or additionally, the optical conductor can be guided along the anchor connection by guide means (for example eyelets).

Preferably, the optical conductor may extend (as viewed in the longitudinal direction of the anchor connection) along substantially the entire anchor connection. In other words, the at least one optical conductor may preferably extend substantially from a first end of the anchor connection connected to the anchor connector to the other end of the anchor connection, which other end is connected to respectively may comprise an anchor (e.g., a foundation). This allows the entire anchor connection to be monitored.

The optical sensor equipment can preferably be based on optical time-domain reflectometry (OTDR).

Preferably, the optical sensor equipment can comprise at least one measurement signal generator. The measurement signal generator can be configured to couple an optical measurement signal into the at least one optical conductor of the anchor connection to be monitored. The sensor equipment may comprise an optical measuring module configured to receive and in particular evaluate the sensor signal generated in response to the optical measurement signal in the optical conductor. In particular, the sensor signal can be based on the measurement signal and the state of the optical conductor and thus the state of the anchor connection (e.g., broken or not broken). By evaluating the sensor signal, a broken anchor connection can then be detected.

As has already been described, the optical sensor equipment can be operated in particular according to the OTDR method. For example, the measurement signal generator can couple at least one light pulse, in particular laser pulse, (with a duration between, for example, 3 ns to 20 μs) into the optical conductor in the form of an optical waveguide as a measurement signal. The backscattered light can be measured over time as the sensor signal, in particular by the measuring module. The (continuously) detected optical parameter can in particular be the sensor signal, e.g., in the form of a detected reflection parameter, such as a backscattered light parameter or a parameter determined therefrom.

As has been described, the optical conductor is preferably attached to the anchor connection in such a way that if the anchor connection breaks, the optical conductor also breaks (at least almost simultaneously). A breaking respectively severing of the optical conductor causes a detectable change of the at least one optical parameter. In particular, a breakage of the optical conductor causes a change of the detected optical parameter in such a way that the detected optical parameter (value) is no longer within the predetermined permissible optical parameter range.

The permissible optical parameter range defines in particular an optical parameter range in which the optical conductor and thus the at least one anchor connection is intact and has not broken, respectively. In particular, at least one optical limit parameter value can be predetermined.

As long as the detected optical parameter values of the at least one detected optical parameter are within the permissible parameter range, it can be assumed that the at least one anchor connection is intact and has not broken, respectively. A triggering of the switching equipment can be omitted. If, on the other hand, the at least one detected optical parameter value is outside the permissible parameter range, an event respectively parameter can be detected that indicates that the at least one anchor connection is (potentially or actually) broken respectively disconnected (or is immediately threatening to break with a high probability (>95%)). A reliable and particularly accurate detection of an in particular broken anchor connection can be provided.

The optical evaluation module can be configured in particular to (continuously) compare the detected optical parameter values with the permissible parameter range. If it is determined that the detected parameter values lie outside the permissible position range, the switching equipment can be triggered (immediately) in the described manner. A reliable and particularly accurate detection of a broken anchor connection in particular can be provided.

Alternatively or additionally, in one embodiment of the floatable offshore structure according to the application, the detection arrangement may comprise at least one mechanical sensor. The mechanical sensor may be configured to detect at least one mechanical parameter of a measuring rope guided at least partially along the anchor connection. The detection arrangement may comprise at least one mechanical evaluation module. The mechanical evaluation module may be configured to detect the anchor connection breakage indication based on the at least one detected mechanical parameter and in particular at least one predetermined permissible mechanical parameter range.

Preferably, a mechanical measuring arrangement may comprise a mechanical sensor and the at least one measuring rope. The measuring rope may, for example, be guided from one end of the anchor connection to the other end of the anchor connection and, in particular, parallel along the anchor connection.

The measuring rope can be attached to the anchor connection in such a way that if the anchor connection breaks, the measuring rope also breaks. Before a breaking respectively severing, the measuring rope tension detectable by the mechanical sensor and/or the distance of movement of the measuring rope detectable by the mechanical sensor can change, in particular due to the broken anchor connection. This can be detected by the mechanical sensor and evaluated by the mechanical evaluation module. In particular, a breakage in the anchor connection causes a detectable change in the detected mechanical parameter such that the detected mechanical parameter (value) is no longer within the specified permissible optical parameter range.

The permissible mechanical parameter range defines in particular a parameter range (e.g., a maximum permissible stress range, a maximum permissible movement distance, etc.) at which the at least one anchor connection is intact and is not broken, respectively. In particular, at least one mechanical limit parameter value (e.g., stress limit value, movement distance limit value) can be predetermined.

As long as the detected mechanical parameter values of the at least one detected mechanical parameter are within the permissible parameter range, it can be assumed that the at least one anchor connection is intact and is not broken, respectively. If, on the other hand, the at least one detected mechanical parameter value is outside the permissible parameter range, an event respectively parameter can be detected that indicates that the at least one anchor connection is (potentially or actually) broken respectively disconnected (or is immediately at risk of breaking with a high probability (>95%)).

The mechanical evaluation module can be configured in particular to (continuously) compare the detected mechanical parameter values with the permissible parameter range. If it is determined that the detected parameter values are outside the permissible parameter range, the switching equipment can be triggered (immediately) in the described manner. Reliable detection of a broken anchor connection can be provided in particular by simple means.

As has already been described, the detection arrangement and the switching equipment may be coupled and connected, respectively, to each other, in particular to be able to trigger a switching operation and thus at least an electrical disconnecting (directly) upon detection of a broken anchor connection. According to a further preferred embodiment of the floatable offshore structure according to the application, the floatable offshore structure may comprise at least one interface arranged between the detection arrangement (in particular the at least one evaluation module) and the switching equipment. The at least one interface may be an analog interface and/or a digital interface and/or a mechanical interface. Preferably, two different interfaces may be provided, such as an analog interface and a digital interface or a digital interface and a mechanical interface. This can ensure that the described switching operation can be triggered even in the event of a defective interface. Preferably immediately upon detection of a broken anchor cable, the detection arrangement can control the switching equipment via the at least one interface in such a way that an electrical interrupting of the electrical connection to the submarine power cable takes place.

In a further embodiment of the floatable offshore structure according to the application, a further mechanical sensor may also be arranged (directly) at the anchor connector, in particular be integrated. The further mechanical sensor may be configured to detect at least one further mechanical parameter of the anchor connection, such as a load applied to the anchor connector (e.g., a retaining bolt of the anchor connector) by the anchor connection. Further, the floatable offshore structure may comprise at least one further mechanical evaluation module. The further mechanical evaluation module may be configured to detect the anchor connection breakage indication of the floatable offshore structure based on the at least one further detected mechanical parameter and in particular at least one further predetermined permissible mechanical parameter range. The detection of the anchor connection breakage indication based on the at least one further detected mechanical parameter and in particular at least one further predetermined permissible mechanical parameter range is performed in particular in an analogous manner to the previously described detection of the broken anchor connection of the floatable offshore structure based on the at least one detected mechanical parameter and in particular at least one predetermined permissible mechanical parameter range, so that reference is made to the corresponding explanations in order to avoid repetitions.

According to a further particularly preferred embodiment of the floatable offshore structure according to the application, the switching equipment, in particular as a switching module, can comprise at least one load break switch. The at least one load break switch is in particular configured to switch (electrical) loads. A load break switch may comprise at least one arc extinguishing module. In particular, arc extinguishing modules may be arranged at the switching contacts of the load break switch. Preferably, the switching equipment can comprise at least one load break switch for each connected submarine power cable.

Preferably, the switching equipment, in particular the at least one load break switch, can be arranged on respectively in the submarine power cable connector. In a safe and simple manner, an electrical connection to a connected submarine power cable can be interrupted and thus, in particular, the submarine power cable can be de-energized.

Furthermore, according to a further embodiment of the floatable offshore structure, the switching equipment may be configured to mechanically disconnect the submarine power cable. An uncontrolled breakaway of the de-energized submarine power cable can be prevented. This can facilitate repair of the damage and further improve safety.

According to a further embodiment of the floatable offshore structure according to the application, the floatable offshore structure may comprise at least one communication equipment. In particular, the at least one communication equipment may be coupled to or integrated in the detection arrangement.

The communication equipment may at least be configured to send at least one alarm message to at least one further structure connected to the floatable offshore structure via the submarine power cable (at which an electrically disconnecting will be performed and in particular a breakaway is expected) upon detection of an anchor connection breakage indication, in particular a broken anchor connection of the floatable offshore structure. At least, the alert message may contain instructions for electrically disconnecting the submarine power cable at the further structure.

The further structure may be an offshore (floatable) structure or an onshore structure.

For example, the communication equipment may comprise a radio module. Preferably, the communication equipment may be coupled to an (optical) communication conductor of the at least one submarine power cable for transmitting the alarm message via the (optical) communication conductor. The further structure may comprise a further switching equipment. The further switching equipment may be configured to at least electrically disconnect the electrical connection to the submarine power cable connected to a further submarine power cable connector of the further structure (directly) upon receipt of the alarm message.

According to a further embodiment of the floatable offshore structure according to the application, the switching equipment comprises a receiving module connected to an (optical) communication conductor of the at least one submarine power cable. The switching equipment, in particular the at least one switching module, may be arranged for at least electrically disconnecting the electrical connection to the submarine power cable (as has already been described), in particular immediately upon receipt of an alarm message, in particular from a (previously described) communication equipment of a further floatable offshore structure.

According to a further embodiment of the floatable offshore structure according to the application, the floatable offshore structure may comprise at least one activating arrangement configured to activate at least one consumer and/or at least one energy source upon or after a detection of an anchor connection breakage indication. The activating may be instantaneous (in particular analogous to the activation of the switching equipment). In particular, the at least one consumer and/or the at least one energy source may be part of a safety system of the offshore structure. For example, the at least one consumer may be an actuator for closing a door (e.g., for safety reasons, doors or gates may be automatically closed upon detection) and/or an actuator for interrupting a fluid flow (e.g., hydrogen flow or a gas produced from hydrogen; for safety reasons, an actuator may in particular automatically close valves or the like in a piping system) and/or a light source (e.g., emergency lighting). The at least one energy source may be, for example, a rechargeable battery and/or a fuel-driven generator (e.g., diesel generator), e.g., configured to supply a aforementioned (electrical) consumer.

In particular, a safety system of the offshore structure (or an adjacent structure) and/or a fire protection system can be activated in an automatic manner upon a corresponding detection.

According to a further embodiment of the floatable offshore structure according to the application, the floatable offshore structure may comprise at least one deactivation arrangement configured to deactivate at least one consumer (of the offshore structure and/or an adjacent structure) and/or at least one energy source (of the offshore structure and/or an adjacent structure) upon or after a detection of an anchor connection breakage indication. The deactivating can be performed immediately (in particular analogously to the activating of the switching equipment). Here, if necessary, shutdown times respectively ramp-down times respectively ramps must be taken into account). In particular, the at least one consumer may be a component of an electrolysis system, such as the electrolyzer, a compressor, a treatment system, a pump and/or the like. In particular, the chemical process may thereby be automatically stopped (as quickly as possible) upon a corresponding detection. Further, for example, the at least one energy source may be a wind power generator and/or a photovoltaic system.

A further aspect of the application is a (floatable) (offshore) power generation system. The power generation system comprises at least one (previously described) floatable offshore structure. The power generation system comprises at least one (previously described) submarine power cable. The power generation system comprises at least one further (previously described) structure electrically connected to the floatable offshore structure via the submarine power cable.

Preferably, the power generation system may be a floatable offshore wind power system respectively an offshore wind power system which is floating in the installation state respectively a floatable offshore wind farm respectively an offshore wind farm which is floating in the installation state. Also, the power generation system may be a floatable offshore photovoltaic system respectively an offshore photovoltaic system which is floating in the state of installation or an offshore hydrogen production system. It shall be understood that the aforementioned systems may be combined. For example, an offshore wind energy system may comprise at least one photovoltaic device and/or at least one hydrogen production device.

A still further aspect of the application is a method. The method comprises:
detecting, by at least one detection arrangement (of an offshore structure), an anchor connection breakage indication (in particular a broken anchor connection of a floatable offshore structure), and
electrically disconnecting, by at least one switching equipment (of the offshore structure), the electrical connection to the submarine power cable connected to a submarine power cable connector of the offshore structure upon or after a detection of an anchor connection breakage indication.

A still further aspect of the application is a use of a detection arrangement configured to detect an anchor connection breakage indication and at least one switching equipment configured to at least electrically disconnect the electrical connection to the submarine power cable connected to a submarine power cable connector of a floatable offshore structure upon or after a detection of an anchor connection breakage indication, in the floatable offshore structure.

The features of the floatable offshore structures, power generation systems, methods and uses are freely combinable with each other. In particular, features of the description and/or dependent claims may be independently inventive, even by completely or partially bypassing features of the independent claims, alone or freely combined with each other.

### BRIEF DESCRIPTION OF THE DRAWINGS

There are now a multitude of possibilities to design and further develop the floatable offshore structure according to the application, the power generation system according to the application, the method according to the application and the use of an anchor cable system according to the application. For this purpose, reference is made on the one hand to the patent claims subordinate to the independent patent claims, and on the other hand to the description of embodiments in connection with the drawing. In the drawing shows:

FIG. 1 shows a schematic view of an embodiment of a floatable offshore structure according to the present application;

FIG. 2 shows a schematic view of a further embodiment of a floatable offshore structure according to the present application;

FIG. 3 shows a schematic view of a further embodiment of a floatable offshore structure according to the present application;

FIG. 4 shows a schematic view of a further embodiment of a floatable offshore structure according to the present application;

FIG. 5 shows a schematic view of a further embodiment of a floatable offshore structure according to the present application;

FIG. 6 shows a schematic view of an embodiment of a floatable power generation system according to the present application; and

FIG. 7 shows a diagram of an embodiment of a method according to the present application.

### DETAILED DESCRIPTION OF THE INVENTION

In the Figures, similar reference signs are used for similar elements. In addition, z denotes the vertical direction and x a horizontal direction.

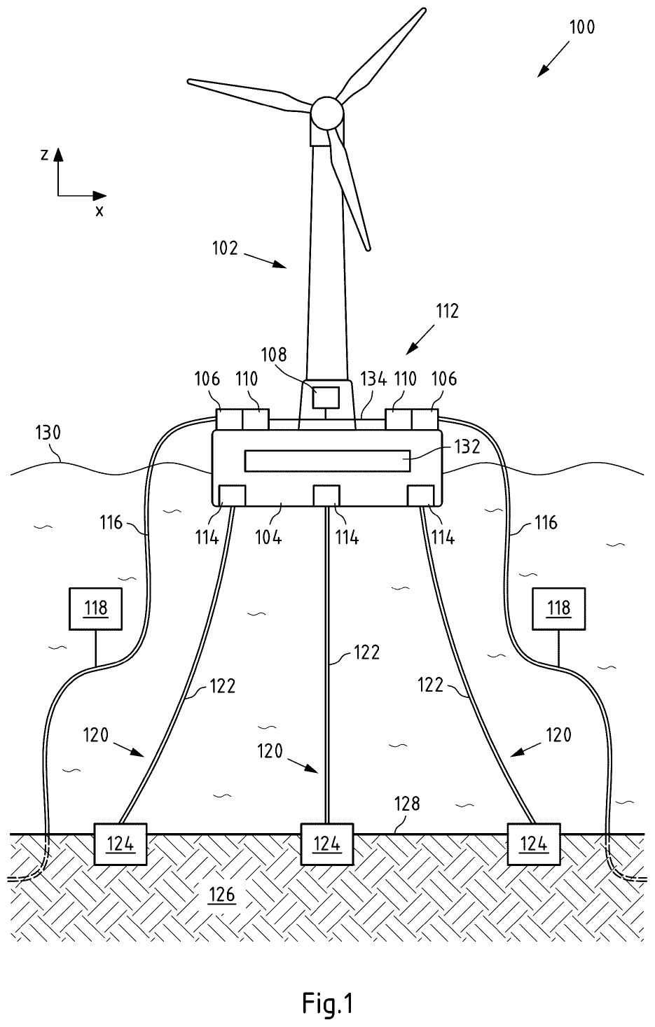

FIG. 1 shows a schematic view of an embodiment of a floatable offshore structure 100 and a floatable offshore structure 100, respectively, according to the present application.

As an example in this embodiment (and the further embodiments below), the floatable offshore structure 100 shown in the installed state is a floatable and floating, respectively, offshore wind turbine 100.

However, the following explanations can be applied to further floatable offshore structures, such as an offshore substation, an offshore photovoltaic device, an offshore hydrogen production device, etc.

A floatable offshore structure 100 according to the application is characterized in particular in that the floatable offshore structure 100 comprises at least one submarine power cable connector 106 and at least one anchor connector 114. The at least one submarine power cable connector 106 is configured to connect a submarine power cable 116. In particular, at least one submarine power cable 116 is connected to the at least one submarine power cable connector 106 of the offshore structure 100 when the offshore structure 100 is in operation, that is, in particular, in an installation state.

Not shown is the internal electrical connection of the offshore power cable 116 to, for example, a generator, converter, etc. of the offshore structure 100 (or PV plant, hydrogen production plant, etc.) and/or the further offshore power cable 116.

A submarine power cable 116 is preferably a medium voltage submarine cable (in particular between 3 kV to 30 kV) or a high voltage submarine cable (60 kV to 110 kV). The power capacity of a marine energy cable 116 according to the application is preferably between 3 MW and 2.5 GW.

For example, a submarine power cable 116 may comprise three phase conductors for transmitting electrical power. Further, at least one optical fiber may be integrated in the submarine power cable 116 as an (optical) communication conductor. It shall be understood that a submarine power cable 116 may comprise further cable elements, such as at least one insulation layer, at least one shielding layer, at least one armoring layer, an outer jacket, filler material, and/or the like.

In the present application, the offshore structure 100 comprises a floatable foundation 104 having at least one (indicated) floating body 132. A device 102 is arranged on the foundation 104, which may in particular comprise the at least one submarine power cable connector 106. In other variations of the application, a submarine power cable connector may also be disposed in respectively on the foundation 104.

In particular, the device 102 is an electrical power generation device 102. As has been described above, the power generation device 102 in the present example is a wind turbine 102 configured to convert the kinetic energy of the wind into electrical energy. In particular, the generated electrical energy is fed into a submarine power cable 116 via the submarine power cable connector 106.

As can be seen, the offshore wind turbine 100 in the present exemplary embodiment comprises two submarine power cable connectors 106, to each of which a submarine power cable 116 is connected. A submarine power cable 116 extends from a submarine power cable connector 106 preferably in an S-shape to the surface 128 of the underwater bottom 126. For this purpose, at least one buoyancy body 118 may be provided and in particular attached to the submarine power cable 116. This may provide a length buffer.

As further indicated in FIG. 1, the at least one submarine power cable 116 is laid in the underwater bottom 126 with a specific depth range and runs in particular to a further structure (not shown here) of the power generation system, such as a further floatable or non-floatable offshore structure or an onshore structure.

In addition, the floatable offshore structure 100 comprises at least one anchor connector 114. In the present example, three anchor connectors 114 are provided. An anchor connection 122 is attached to each anchor connector 114 in the present case. In particular, the anchor connection 122 is part of an anchoring arrangement 120. The offshore structure 100 may comprise the at least one anchoring arrangement 120.

In particular, an anchoring arrangement 120 comprises at least one anchor connection 122 and an anchor 124. In the illustrated installation and operating state of the floatable offshore structure 100, the anchor 124 is at least partially anchored in the underwater bottom 126. A first end of the anchor connection 122 is attached to the anchor connector 114 and the other end of the anchor connection 122 is attached to the anchor 124.

According to the application, the floatable offshore structure 100 comprises a detection arrangement 108 and a switching equipment 112 as a safety system. In particular, the switching equipment 112 comprises at least one switching module 110, preferably in the form of a load break switch 110. Preferably, at least one switching module 110 may be provided for each connected submarine power cable 116, for example, one load break switch 110 may be provided for each phase conductor of each submarine power cable 116. In particular, the at least one switching module 110 may be arranged immediately adjacent to the at least one submarine power cable connector 106 or may be integrated into the submarine power cable connector 106.

The switching equipment 112 is connected to the detection arrangement 108 via at least one interface 134 (e.g., a digital interface, analog interface, and/or mechanical interface).

The detection arrangement 108 is configured to detect an anchor connection breakage indication, in particular a broken anchor connection 122, and thus serves in particular to directly and/or indirectly monitor the at least one anchor connection 122 of the floatable offshore structure 100, in particular all anchor connections 122 of the floatable offshore structure 100. A broken anchor connection is present at least when the connection to the anchor 124 of the anchoring arrangement 120 is broken.

Upon detection of an anchor connection breakage indication, at least an electrical disconnecting (respectively switching off) of the electrical connection to the submarine power cable 116 respectively interrupting of the flow of power through respectively to the submarine power cable 116 is performed by the switching equipment 112. Preferably, a corresponding electrical disconnecting is performed at all submarine power cables 116 connected to the floatable offshore structure 100. In other words, the at least one submarine power cable 116 is de-energized, preferably by triggering the at least one load break switch 110.

In particular, the at least electrical disconnecting occurs immediately respectively directly upon or after the detection of a broken anchor connection 122. This means that the switching equipment 112 is triggered immediately (e.g., <1 sec) upon or after the detection of the anchor connection breakage indication such that the at least one submarine power cable 116 is immediately de-energized. In variants of the application, the switching equipment 112 may also be triggered within a greater period of time (e.g., less than 10 seconds, preferably less than 5 seconds) upon or after the detection of the anchor connection breakage indication such that the at least one submarine power cable 116 is de-energized.

The reference sign 130 indicates the water surface.

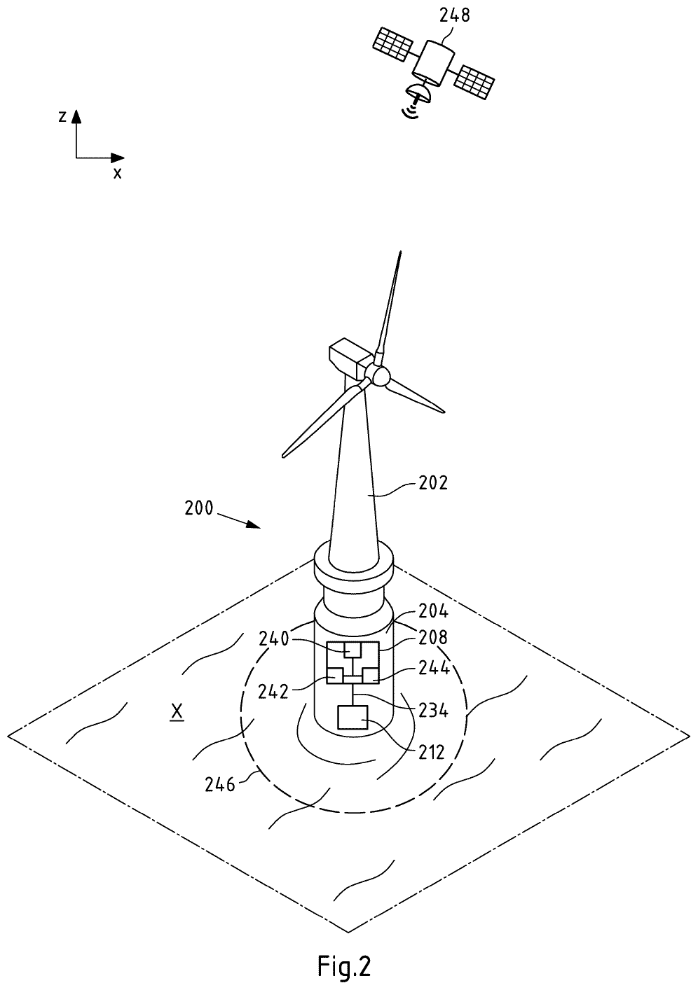

FIG. 2 shows a schematic view of a further embodiment of a floatable offshore structure 200 according to the present application. In order to avoid repetitions, essentially only the differences to the embodiment already shown are described below. Otherwise, reference is made to the explanations of FIG. 1. In particular, it is noted that for the sake of a better overview, certain details of the floatable offshore structure 200, such as submarine power cable connector, anchor connector, etc., have been omitted.

The detection arrangement 208 of the floatable offshore structure 200 comprises at least one position sensor 240, at least one position evaluation module 242, and at least one memory module 244. The at least one position sensor 240 is in particular configured to detect (in particular measure) the (instantaneous) geographic position of the floatable offshore structure 200. The at least one position sensor 240 is in particular a satellite-based position sensor 240 (e.g., GPS sensor, Galileo sensor, etc.). Satellites 248 may transmit encoded signals continuously. From the information contained in the signals, the position sensor 240 may in particular calculate the instantaneous position of the floatable offshore structure 200.

In particular, the at least one position sensor 240 is configured to substantially continuously detect and calculate, respectively, the instantaneous position of the floatable offshore structure 200.

The illustrated position evaluation module 242 is configured to evaluate the detect the position in order to detect, in particular, the presence of an anchor connection breakage indication. In particular, the detection of an anchor connection breakage indication is based on the detected geographic position and a predetermined permissible geographic position range of the floatable offshore structure 200. In particular, this position range respectively the corresponding position data may be stored in the memory module 244. The memory module 244 may be accessed by the position evaluation module 242.

In particular, the geographic permissible position range is the maximum possible range of movement in which the floatable offshore structure 200 can maximally move in the installation state of the floatable offshore structure 200 without an anchor connection being broken. This range is indicated by the dashed line 246 in FIG. 2. In particular, if one anchor connection, for example, of a plurality of anchor connections, breaks, then the maximum possible range of movement of the floatable offshore structure 200 increases so that the floatable offshore structure 200 may be outside of the area 246 when the anchor connection is broken. A position monitoring system can therefore be used to reliably detect an anchor connection breakage indication, in particular, a broken anchor connection, as will be described in further detail.

In particular, the permissible position range may be determined prior to commissioning of the floatable offshore structure 200. In particular, the permissible position range may depend on parameters such as the length of the at least one anchor connection, the number of connected anchor connections, a provided length buffer of the at least one submarine power cable, and/or the like. For example, the longer the anchor connections respectively the greater the water depth at the installation site of the offshore structure, the greater the maximum range of motion of a floatable offshore structure 200.

The offshore power cable may have an appropriate length buffer, for example, it may have an S-shaped curve as shown in FIG. 1. With an offshore structure 200 moving within the maximum range of movement and permissible position, respectively, it is ensured that the submarine power cable is not damaged.

The detected geographic position and the detected position data, respectively, in particular in the form of geographic coordinates (e.g., GPS data), are presently (continuously) provided to the position evaluation module 242. The position evaluation module 242 can (continuously) compare the provided position data with the permissible position range, which can also be defined by position data.

If the detected position data is within the permissible position range respectively meets the permissible position range (i.e., the floatable offshore structure 200 is positioned within the range 246), it can be determined that the at least one anchor connection is intact and not broken, respectively. A triggering of the switching equipment 212 does not occur.

On the other hand, if the position data of the offshore structure 200 is outside of respectively does not meet the permissible position range (in which case the floatable offshore structure 200 is outside of the range 246, for example, at position X), an event and parameter, respectively, may be detected that indicates that the at least one anchor connection is (potentially or actually) broken respectively disconnected (or is imminently at a high probability of breaking).

As has been described, the position evaluation module 242 is in particular configured to continuously compare the detected position respectively the detected position data with the permissible position range. If it is determined that the detected position respectively the detected position data of the floatable offshore structure 200 is/are outside the permissible position range, the switching equipment 212 can preferably be immediately triggered and actuated, respectively, in the described manner.

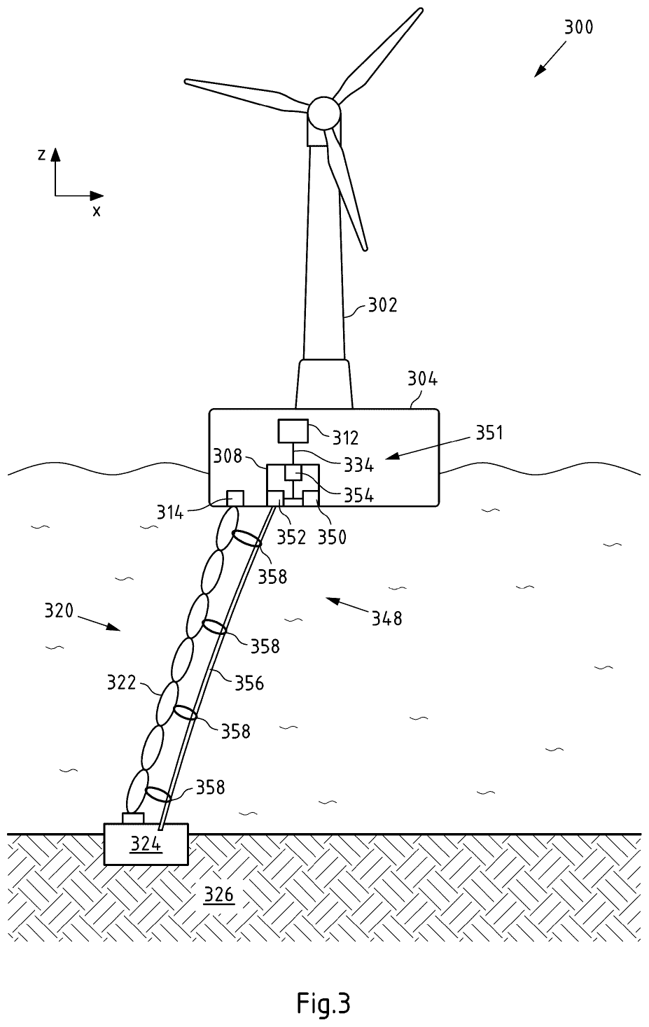

FIG. 3 shows a schematic view of a further embodiment of a floatable offshore structure 300 according to the present application. In order to avoid repetitions, essentially only the differences to the already shown embodiments are described below. Otherwise, reference is made to the explanations of FIGS. 1 and/or 2. In particular, it is noted that for the sake of a better overview, certain details, such as submarine power cable connectors, submarine power cable, etc., have been omitted. Also, by way of example, only one anchoring arrangement 320 has been shown for ease of reference. It shall be understood that two or more anchoring arrangements may be provided.

The floatable offshore structure 300 comprises a detection arrangement 308. In the present case, the detection arrangement 308 comprises an electrical sensor equipment 351 and an electrical evaluation module 354. In particular, the electrical sensor equipment 351 comprises a generator 350 and a measuring module 352.

In the present example, an anchor chain 322 is provided as the anchor connection 322. In variants of the application, an anchor rope can also be provided as an anchor connection.

Furthermore, in the present embodiment, an electrical sensor arrangement 348 is provided, which may be formed by the electrical sensor equipment 351 and at least one electrical (measuring) conductor 356. The floatable offshore structure 300 may comprise the at least one electrical sensor arrangement 348 and/or the at least one anchoring arrangement 320.

The electrical sensor arrangement 348 comprises at least one electrical conductor 356. The electrical conductor 356 may be guided at least partially along the anchor connection 322. As can be seen from FIG. 3, in the present case the electrical conductor 356 is guided along the entire length of the anchor connection 322, i.e., from the first end of the anchor connection 322 connected to the anchor connected 314 to the other end of the anchor connection 322 connected to the anchor 324. In particular, a plurality of eyelets 358 may be disposed on the anchor connection 322 for this purpose. The electrical conductor 356 may be guided through the eyelets 356, wherein a first end of the electrical conductor 356 may be connected to the detection arrangement 308 and the other end of the electrical conductor may be connected to the anchor 324, for example. In particular, the other end of the electrical conductor 356 may extend in the anchor 324 such that if the electrical conductor 356 is broken from the anchor, a portion of the electrical conductor 356 will always remain in the anchor 324.

The electrical conductor 356 may have an insulation in the form of a protective layer and, in particular, a forward line and a return line that are electrically insulated from each other. The first end of the forward line may be connected to the generator 350, the other end in the region of the other respectively lower end of the electrical conductor 356 may be connected to the other end of the return line, and the first end of the return line may be connected to the generator 350, so that in particular a closed circuit is formed. Further, the measuring module 352 may be coupled to the first ends of the forward line and the return line to measure an applied electrical parameter.

In particular, the generator 350 is configured to apply a particular voltage and/or current to the electrical conductor 356. For example, a specific voltage may be applied to the forward line and the return line. In particular, the measuring module 352 is configured to detect, in particular measure, at least one electrical parameter (e.g., voltage, current, magnetic field, electric field, present at the electrical conductor 356. For example, the measuring module 352 may measure current.

In particular, when the anchor connection 322 breaks, the electrical conductor 356 also breaks. In particular, the breaking of the electrical conductor 356 results in a measurable change in the electrical parameter present at the electrical conductor 356. In particular, a permissible electrical parameter range may be predetermined. This may in particular depend on the (predetermined) applied electrical parameter, the resistance of the electrical conductor 356 and/or the length of the electrical conductor 356.

In particular, the permissible electrical parameter range defines a parameter range at which the at least one anchor connection 322 is intact respectively is considered not to be broken. In particular, at least one electrical limit parameter value may be predetermined.

As long as the detected electrical parameter value of the at least one detected electrical parameter is within the permissible parameter range, for example, does not exceed (or fall below) the limit parameter value, it can be assumed that the at least one anchor connection 322 is intact. On the other hand, if the at least one detected electrical parameter value is outside the permissible parameter range, for example, if the detected electrical parameter value exceeds (or falls below) the limit parameter value, an event respectively parameter may be detected that indicates that the at least one anchor connection 322 is (potentially or actually) broken respectively disconnected (or is imminently likely to break). Then, the switching equipment 312 may be triggered in the manner described above.

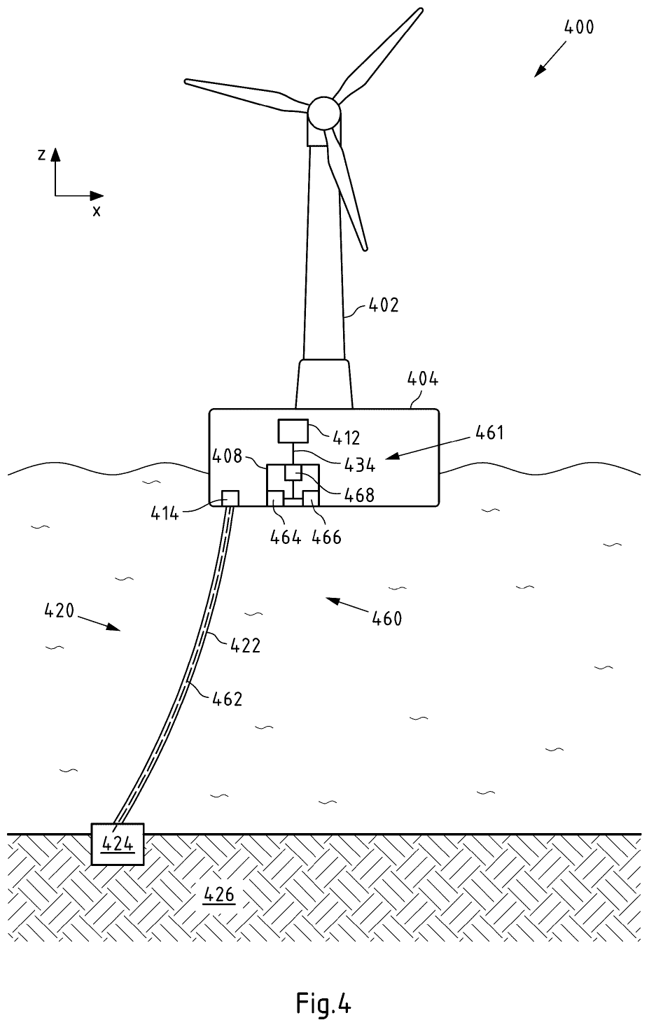

FIG. 4 shows a schematic view of a further embodiment of a floatable offshore structure 400 according to the present application. In order to avoid repetitions, essentially only the differences to the already shown embodiments are described below. Otherwise, reference is made to the explanations of FIGS. 1, 2 and/or 3. In particular, it is noted that for the sake of a better overview, certain details, such as submarine power cable connector, submarine power cable, etc., have been omitted. Also, by way of example, only one anchoring arrangement 420 has been shown for ease of reference. It shall be understood that two or more anchoring arrangements may be provided.

In particular, in the illustrated embodiment, an optical sensor equipment 461 is provided as the anchor connection structure sensor instead of an electrical sensor equipment, as in FIG. 3.

The optical sensor equipment 461 comprises a measurement signal generator 464 and a measuring module 466. In addition to the optical sensor equipment 461, the detection arrangement 408 comprises an optical evaluation module 468.

Furthermore, the at least one anchor connection 422 is formed as an anchor rope 422. An optical conductor 462 in the form of an optical waveguide 462 is presently integrated in the anchor rope 422. As can be seen, in the shown preferred embodiment, the optical fiber 462 extends from the first end of the anchor rope 422 attached to the anchor connector 414 to the other end of the anchor rope 422 attached to the anchor 424. In particular, the first end of the optical waveguide may be coupled to the sensor equipment 461. The sensor equipment 461 and the optical waveguide 462 may form an optical sensor arrangement. The other end of the optical waveguide 462 may be attached to the anchor 424. In particular, the other end of the optical waveguide 462 may extend in the anchor 424 such that if the optical fiber 462 is broken from the anchor 424, a portion of the optical fiber 462 will always remain in the anchor 424.

The measurement signal generator 464 is presently configured to couple an optical measurement signal into the at least one optical conductor 462 of the anchor connection 422 to be monitored. The optical measuring module 466 is presently configured to receive and in particular evaluate the sensor signal generated in response to the optical measurement signal in the optical conductor 462. In particular, the evaluation may be based on the measurement signal and the sensor signal that caused the measurement signal in order to determine whether or not an anchor connection 422 is broken.

The illustrated optical evaluation module 468 is configured to detect the broken anchor connection 422 based on the at least one detected optical parameter and at least one predetermined permissible optical parameter range.

The optical sensor equipment 461 is operated in the present case in particular according to the OTDR method. For example, the measurement signal generator 464 can couple at least one light pulse, in particular laser pulse, (with a duration between, for example, 3 ns to 20 μs) into the optical conductor 462 as a measurement signal. The backscattered light can be measured over time as the sensor signal, in particular by the measuring module 466. The time dependence of the sensor signal can, for example, be converted into a location dependence, so that a spatially resolved determination of the mechanical structural state of the anchor connection 422 (for example, based on the vibration data, sound data, etc. obtained from the measurement signal) can be made. The (continuously) detected optical parameter is in particular the sensor signal and may be, for example, a detected reflection parameter, such as a backscattered light parameter or a parameter determined therefrom.

The optical conductor 462 is attached to the anchor connection 422, in particular integrated, in such a way that if the anchor connection 422 breaks, the optical conductor 462 also breaks (simultaneously). A breaking respectively severing of the optical conductor 462 causes a detectable change of the at least one detected optical parameter. In particular, a breakage of the optical conductor 462 causes a change of the detected optical parameter such that the detected optical parameter (value) is no longer within the predetermined permissible optical parameter range.

In particular, the permissible optical parameter range defines a parameter range in which the at least one anchor connection 422 is intact and is not broken, respectively. In particular, at least one optical limit parameter value can be predetermined.

As long as the detected optical parameter values of the at least one detected optical parameter lie within the permissible parameter range, i.e., in particular do not exceed (or fall below) the optical limit parameter value, it can be assumed that the at least one anchor connection is intact and has not broken, respectively. If, on the other hand, the at least one detected optical parameter value is outside the permissible parameter range, it can be assumed respectively an event can be detected, for example, if the optical limit parameter value is exceeded (or fallen below), that the at least one anchor connection 422 is (potentially or actually) broken respectively disconnected (or is immediately at risk of breaking with a high probability). Then, the switching equipment 412 may be triggered in the manner described above.

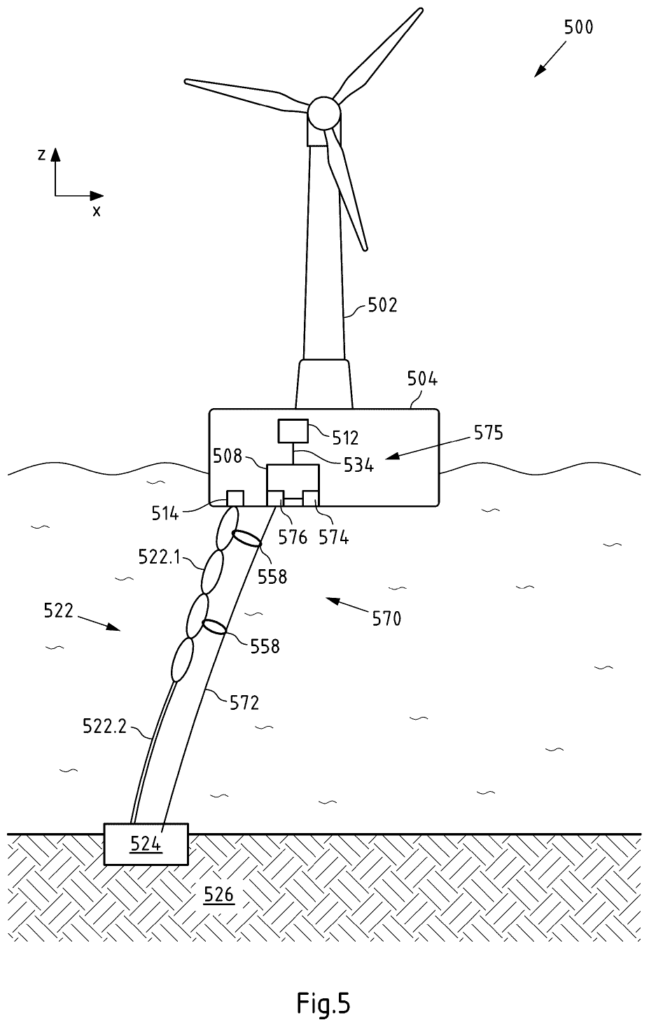

FIG. 5 shows a schematic view of a further embodiment of a floatable offshore structure 500 according to the present application. In order to avoid repetitions, essentially only the differences from the already shown embodiments are described below. Otherwise, reference is made to the explanations of FIGS. 1, 2, 3 and/or 4. In particular, it is noted that for the sake of a better overview, certain details, such as submarine power cable connector, submarine power cable, etc., have been omitted. Also, by way of example, only one anchoring arrangement 520 has been shown for ease of reference. It shall be understood that two or more anchoring arrangements may be provided.

In particular, in the illustrated embodiment, the anchor connection structure sensor is a mechanical sensor equipment 575 instead of an electrical sensor equipment, as in FIG. 3, or an optical sensor equipment, as in FIG. 4. In variants of the application, a plurality of different sensor equipment may be provided.

In the present example, the anchor connection 522 is a combination of an anchor chain 522.1 and an anchor rope 522.2. A measuring rope 572 is guided along the entire length of the anchor connection 522 according to the illustrated preferred embodiment, for example using eyelets as guide elements. The first end may be coupled to the mechanical sensor equipment 575. Sensor equipment 575 and measuring rope 572 may form a mechanical sensor arrangement. The other end of the sensing cable 572 may be attached to the anchor 524.

In the present case, the mechanical sensor equipment 575 is formed in particular by a mechanical sensor 576 that is coupled to the measuring rope 572. In particular, the mechanical sensor 576 is configured to detect at least one mechanical parameter of the measuring rope 572.

In the present embodiment, the detection arrangement 508 further comprises at least one mechanical evaluation module 574. The mechanical evaluation module 574 may be configured to detect the broken anchor connection 522 based on the at least one detected mechanical parameter and at least one predetermined permissible mechanical parameter range.

The measuring rope 572 may be attached to the anchor connection 522 in such a way that if the anchor connection 522 breaks, the measuring rope 572 also breaks. Prior to a breakage respectively severing of the measuring rope 572, the measuring rope tension detectable by the mechanical sensor 576 and/or the distance of movement of the measuring rope 572 detectable by the mechanical sensor 576 may change, in particular due to the broken anchor connection 522. This can be detected by the mechanical sensor 576 and evaluated by the mechanical evaluation module 574. In particular, a breakage of the anchor connection 522 causes a change in the detected mechanical parameter such that the detected mechanical parameter (value) is no longer within the predetermined permissible optical parameter range.

In particular, the permissible mechanical parameter range defines a parameter range (e.g., a maximum permissible stress range, a maximum permissible movement range, etc.) at which the at least one anchor connection 522 is intact and is not broken, respectively. In particular, at least one mechanical limit parameter value (e.g., stress limit value, movement distance limit value) may be specified.

As long as the detected mechanical parameter values of the at least one detected mechanical parameter are within the permissible parameter range, i.e., in particular, the limit parameter value is not exceeded (or fallen below), it can be assumed that the at least one anchor connection 522 is intact and has not broken, respectively. If, on the other hand, the at least one detected mechanical parameter value is outside the permissible parameter range, i.e., if, for example, the limit parameter value is exceeded (or fallen below), an event respectively parameter can be detected that indicates that the at least one anchor connection 522 is (potentially or actually) broken respectively disconnected (or is immediately at risk of breaking with a high probability). Then, preferably, the switching equipment 512 may be immediately triggered as previously described.

The described embodiments of FIGS. 2 to 5 can be combined with each other. For example, the embodiment of FIG. 2 can be combined with an embodiment of FIGS. 3 to 5. In this way, for example, an anchor connection breakage indication, in particular a broken anchor connection, can be reliably detected even in the case of a faulty position sensor or a faulty anchor connection structure sensor. Also, in variants of the application, a further (not shown) mechanical sensor may be arranged (directly) at the anchor connection, in particular integrated, and configured to detect at least one further mechanical parameter of the anchor connection, such as a load exerted on the anchor connection (e.g., a retaining bolt of the anchor connection) by the anchor connection. A further mechanical evaluation module may be configured to detect an anchor connection breakage indication based on the at least one further detected mechanical parameter and in particular at least one further predetermined permissible mechanical parameter range.

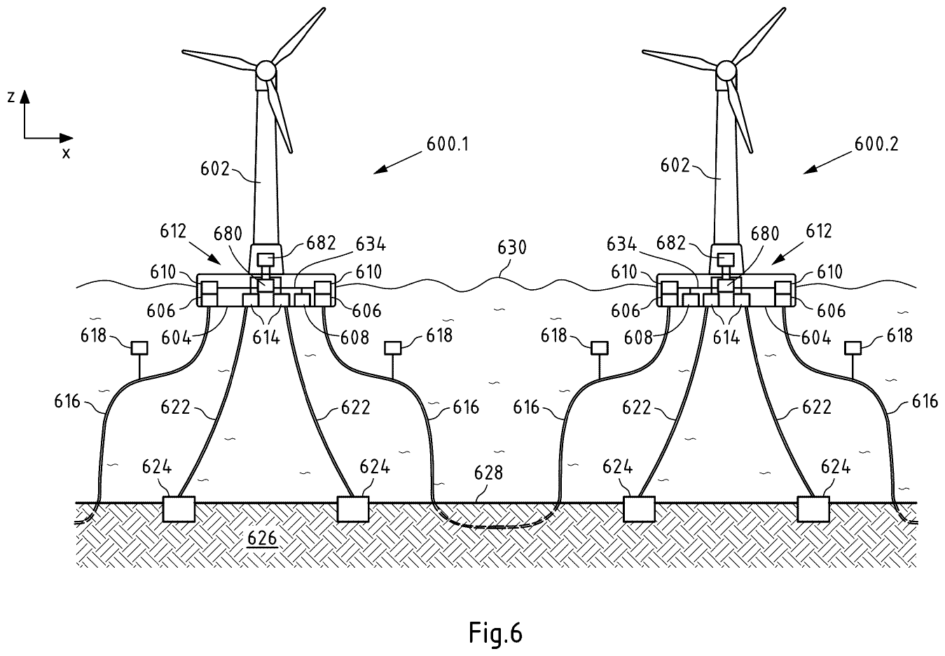

FIG. 6 shows a schematic view of an embodiment of a floatable power generation system 684 according to the present application.

In order to avoid repetitions, only the differences to the previously described embodiments are described below. Otherwise, reference is made to the explanations of FIGS. 1, 2, 3, 4 and/or 5. In particular, it is noted that certain details have been omitted in favor of a better overview. In particular, the detection of an anchor connection breakage can be carried out according to the explanations for FIGS. 1, 2, 3, 4 and/or 5.

The power generation system 684 comprises at least one floatable offshore structure 600.1 with a switching equipment 612 according to the application and a detection arrangement 608 according to the application (cf. in particular FIGS. 1 to 5).

Further, the power generation system 684 comprises at least one submarine power cable 616 described above and at least one further structure 600.2 electrically connected to the floatable offshore structure 600.1 via the submarine power cable 616. In the present example, the further structure 600.2 is formed as a further floatable offshore structure 600.2 formed substantially identically to the first floatable offshore structure 600.1.

The switching equipment 612 of a floatable offshore structure 600.1, 600.2 comprises, in addition to the at least one switching module 610, in particular a receiving module 680. The receiving module 680 is in particular connected to the (optical) communication conductor of the at least one connected submarine power cable 616, preferably to all submarine power cables 616 connected to the respective floatable offshore structure 600.1, 600.2. In other variants of the application, a wirelessly operable receiving module (e.g., a radio module) may be provided alternatively or additionally.

Furthermore, in the present embodiment, a floatable offshore structure 600.1, 600.2 comprises a communication equipment 682. Preferably, the communication equipment 682 may be coupled to the detection arrangement 608. Preferably additionally, the communication equipment 682 may be coupled to the (optical) communication conductor of the at least one connected submarine power cable 616, preferably to all submarine power cables 616 connected to the floatable offshore structure 600.1, 600.2. In other variants of the application, a wirelessly operable communication equipment (e.g., radio module) may be provided alternatively or additionally.

In variants of the application, the receiver module can be integrated in the communication equipment.

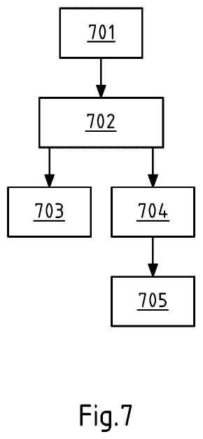

An exemplary method of operation is described in more detail below with the aid of FIG. 7. FIG. 7 shows a diagram of an embodiment of a method according to the present application.

In principle, the state of the at least one anchor connection can be continuously monitored by the detection arrangement according to the application. In particular, it can be continuously checked whether the at least one detected parameter (e.g., geographic position, electrical parameter, optical parameter, and/or mechanical parameter) satisfies the at least one permissible parameter range (e.g., position range, electrical parameter range, optical parameter range, and/or mechanical parameter range). In particular, the continuously detected parameter values of the at least one parameter may be continuously compared to the at least one permissible parameter range to determine whether or not the parameter values are within the permissible parameter range.

In a step 701, by the detection arrangement of the first floatable offshore structure, a detecting of an anchor connection breakage indication is performed, in particular based on a determining that a detected parameter does not meet the permissible parameter range, in particular is outside the permissible parameter range.

Optionally, in step 702, by a communication equipment of the first floatable offshore structure, an alarm message may be sent to at least one further structure connected to the first floatable offshore structure via the submarine power cable to be de-energized immediately upon or after a detection of an anchor connection breakage indication.

The alarm message may contain instructions for electrically disconnecting the connection to the submarine power cable. The further structure may be, for example, as shown in FIG. 6, a further floatable offshore structure. Preferably, the communication equipment may be configured to transmit the alarm message via the (optical) communication conductor of the submarine power cable to be de-energized.

Then, in step 703, at least an electrical disconnecting of the electrical connection to the submarine power cable is performed by the switching equipment (immediately) after or upon detection of an anchor connection breakage indication and/or (immediately) after transmission of the alarm message. In particular, all submarine power cables connected to the offshore structure are de-energized, in particular by load break switches of the switching equipment.

In an optional step 704, by a receiving module of a switching equipment of the further structure, the transmitted alarm message is received.

In an optional step 705, at least an electrical disconnecting of the electrical connection to the submarine power cable electrically connecting the further structure to the first floatable offshore structure is performed by the switching equipment of the further structure.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A floatable offshore structure, comprising:
at least one submarine power cable connector configured to connect a submarine power cable,
at least one anchor connector configured to connect at least one anchor connection for anchoring the floatable offshore structure to an underwater bottom,
at least one detection arrangement configured to detect an anchor connection breakage indication, and
at least one switching equipment configured to at least electrically disconnect the electrical connection to the submarine power cable connected to the submarine power cable connector upon or after the detection of the anchor connection breakage indication.

2. The floatable offshore structure according to claim 1, wherein
the floatable offshore structure comprises a foundation having at least one floating body, and
the floatable offshore structure comprises at least one device arranged on the foundation and having the submarine power cable connector.

3. The floatable offshore structure according to claim 1, wherein
the detection arrangement comprises at least one position sensor configured to detect the position of the floatable offshore structure, and
the detection arrangement comprises at least one position evaluation module configured to detect the anchor connection breakage indication based on the detected position and a predetermined permissible position range.

4. The floatable offshore structure according to claim 1, wherein
the detection arrangement comprises at least one anchor connection structure sensor configured to detect at least one anchor connection structure parameter of the anchor connection, and
the detection arrangement comprises at least one anchor connection structure evaluation module configured to detect the anchor connection breakage indication based on the at least one detected anchor connection structure parameter and at least one predetermined permissible anchor connection structure parameter range.

5. The floatable offshore structure according to claim 1, wherein
the detection arrangement comprises at least one electrical sensor equipment configured to detect at least one electrical parameter of an electrical conductor guided at least partially along the anchor connection, and
the detection arrangement comprises at least one electrical evaluation module configured to detect the anchor connection break indication based on the at least one detected electrical parameter and at least one predetermined permissible parameter range.

6. The floatable offshore structure according to claim 1, wherein
the detection arrangement comprises at least one optical sensor equipment configured to detect at least one optical parameter of an optical waveguide guided at least partially along the anchor connection, and
the detection arrangement comprises at least one optical evaluation module configured to detect the anchor connection breakage indication based on the at least one detected optical parameter and at least one predetermined permissible optical parameter range.

7. The floatable offshore structure according to claim 1, wherein
the detection arrangement comprises at least one mechanical sensor equipment configured to detect at least one mechanical parameter of a measuring rope guided at least partially along the anchor connection, and
the detection arrangement comprises at least one mechanical evaluation module configured to detect the anchor connection break indication based on the at least one detected mechanical parameter and at least one predetermined permissible mechanical parameter range.

8. The floatable offshore structure according to claim 1, wherein
the floatable offshore structure comprises at least one interface arranged between the detection arrangement and the switching equipment,
wherein the at least one interface is an analog interface and/or a digital interface and/or a mechanical interface.

9. The floatable offshore structure according to claim 1, wherein
the switching equipment comprises at least one load break switch.

10. The floatable offshore structure according to claim 1, wherein
the switching equipment is configured to mechanically disconnect the submarine power cable.

11. The floatable offshore structure according to claim 1, wherein
the floatable offshore structure comprises at least one communication equipment configured to send an alarm message to at least one further structure connected to the offshore structure via the submarine power cable upon or after the detection of an anchor connection breakage indication,
wherein the alarm message comprises instructions to electrically disconnect the electrical connection to the submarine power cable at the further structure.

12. The floatable offshore structure according to claim 1, wherein
the switching equipment comprises at least one receiving module configured to receive at least one alarm message containing instructions for electrically disconnecting the submarine power cable,
wherein the switching equipment is configured to at least electrically disconnect the electrical connection to the connected submarine power cable upon receipt of the alarm message.

13. The floatable offshore structure according to claim 1, wherein
the floatable offshore structure comprises at least one activation arrangement configured to activate at least one consumer and/or at least one energy source upon or after the detection of an anchor connection breakage indication,
wherein the at least one consumer is an actuator for closing a door and/or an actuator for interrupting a fluid flow and/or a light source,
and/or
wherein the at least one energy source is a rechargeable battery and/or a fuel-driven generator.

14. The floatable offshore structure according to claim 1, wherein
the floatable offshore structure comprises at least one deactivation arrangement configured to deactivate at least one consumer and/or at least one energy source upon or after the detection of an anchor connection breakage indication,
wherein the at least one consumer is at least one component of an electrolysis system, and/or
wherein the at least one energy source is a wind power generator and/or a photovoltaic system.

15. A power generation system, comprising:
at least one floatable offshore structure according to claim 1,
at least one submarine power cable, and
at least one further structure electrically connected to the floatable offshore structure via the submarine power cable.

16. A method, comprising:
detecting, by at least one detection arrangement, an anchor connection breakage indication, and
electrically disconnecting, by at least one switching equipment, the electrical connection to the submarine power cable connected to a submarine power cable connector of the offshore structure upon or after a detection of the anchor connection breakage indication.

17. A use of a detection arrangement configured to detect an anchor connection breakage indication and at least one switching equipment configured to at least electrically disconnect the electrical connection to the submarine power cable connected to a submarine power cable connector of a floatable offshore structure upon or after a detection of an anchor connection breakage indication in the floatable offshore structure.

18. The floatable offshore structure according to claim 2, wherein
the device is an electrical power generation device.
